(19) United States
(12) Patent Application Publication
(10) Pub. No.: US 2012/0159135 A1
(43) Pub. Date: Jun. 21, 2012

(54) SYSTEM AND METHOD FOR MANAGING HETEROGENOUS RFID/SENSOR DEVICE

(75) Inventor: Sang Yeol PARK, Cheju (KR)

(73) Assignee: Java Information Technology Ltd., Cheju (KR)

(21) Appl. No.: 12/972,099

(22) Filed: Dec. 17, 2010

(51) Int. Cl. G06F 9/00

(52) U.S. Cl. 713/1

(57) ABSTRACT

Provided is a system for dynamically managing various heterogeneous RFID/sensor devices based on a configuration collection required at a RFID/USN middleware for providing a ubiquitous service. In an embodiment, a system for managing a heterogeneous RFID/sensor device includes a control manager for generally managing a main function of a middleware; a configuration manager for reading a configuration information of the middleware and executing each of modules; a queue manager for managing a queue where an input data is stored; a database manager for managing a database; a utility manager for managing a utility necessary to a function of the each of the modules; a reporter manger for sending a data result processed by the middleware; and a driver manager for managing a driver by interworking with a middleware-managing tool. According to the embodiment, various RFID/sensors can be connected, and the cost can be reduced.

### BACKGROUND

Embodiments relate to a system for managing a heterogeneous RFID (radio frequency identification)/sensor device. More particularly, embodiment relates to a system for dynamically managing various heterogeneous RFID/sensor devices based on a collection of a configuration required at a RFID/USN (ubiquitous sensor network) middleware for providing a ubiquitous service.

In recent days, the major talking point in an information communication is the ubiquitous computing. The ubiquitous computing is called a new information technology (IT) revolution in the 21st century, and has a large influence in all field such as society, economy, culture, etc.

In the ubiquitous computing, various computers are contained in devices, environments, and objects. Thus, in the ubiquitous technology, by building the network system and the optimal computing of humans, objects, and spaces, the communication service can be used by any devices at any time and anywhere. That is, the computer can be used naturally and conveniently in life.

In order to build a ubiquitous application service, a middleware technology (that is, a RFID/USN software technology) is necessary for connecting a RFID/USN hardware to an application or enterprise system.

A RFID/USN middleware is the representative RFID/USN software technology, and generally indicates a system software connecting the RFID reader and sensor to the application.

RFID tags attached to the object, RFID reader for reading the RFID tags, and the RFID/USN software, for providing the useful information to the application by processing the data collected from the sensor device, should be organically built so that RFID/USN technology is effectively used to application fields.

The RFID/USN middleware must be able to filter the huge amounts of data collected from various RFID/sensor devices, process the event data, summarize the event data as a meaningful information, and forward them to the service system.

Currently, the building the RFID/USN system and developing the technology is performed by a closed type that restrictedly shares information of the particular field, focused on a passive RFID/USN technology that is mainly used for logistics and distributions. As a result, the RFID/USN middleware is also specialized to a particular company and some industries and should be redesigned and redeveloped all the time. Thus, it is concentrated to a basic function (such as, the data access through the RFID/USN device, or the storage and process of the data collected from the device), and is subordinate to the specific hardware and the specific application.

Using a reader and a sensor with a superior performance or expanding the enterprise system is not enough to reduce the cost of the automotive data collection, to improve the process, and to create the new service.

The RFID/USN middleware should be able to ensure the compatibility of various types of reader and sensor device interface, interworking between various data and network, and various application platforms.

### SUMMARY

Embodiments provide a system for effectively managing a heterogeneous RFID/sensor device using various protocols and/or an addition of a new device or a deletion of the device. For reference, the readers use various protocols defined by reader manufacture, and the sensors uses a plurality of protocols.

In one embodiment, a system for managing a heterogeneous RFID/sensor device includes a control manager for generally managing a main function of a middleware; a configuration manager for reading a configuration information of the middleware and executing each of modules; a queue manager for managing a queue where an input data is stored; a database manager for managing a database; a utility manager for managing a utility necessary to a function of the each of the modules; a reporter manger for sending a data result processed by the middleware; and a driver manager for managing a driver by interworking with a middleware-managing tool.

The data may be input and output by a FIFO (first-in first-out) method.

The middleware-managing tool may notify to the middleware when a device generates or a device information changes.

The middleware-managing tool may manage the device information in a XML (extensible markup language) format.

The XML format document may be displayed by a logical reader and a physical reader.

The logical reader may include the device information and the queue information.

The physical reader may include a device name, an internet protocol (IP) address for connecting to a network, a port number, and an information of a driver implementing a device interface.

In another embodiment, a method for managing a heterogeneous RFID/sensor device includes notifying an information that a device is added when the device is added; generating a listener after notifying the information that the device is added; driving the generated listener; updating a configuration document of the device if the listener is generated; notifying the driving of the listener after updating the configuration document of the device; and notifying the connection of the device after notifying the driving of the listener.

The information that a device is added may be notified to a configure manager.

The listener may be generated by a control of a device manager.

The updating the configuration document may be performed through reading the device information by a XML utility class.

The driving of the listener may be notified to a configure manager.

The connection of the device may be notified by a configure manager.

### BRIEF DESCRIPTION OF THE DRAWINGS

FIG. 1 illustrates a middleware for managing a heterogeneous RFID/sensor device.

FIG. 2 illustrates a XML document for managing the heterogeneous RFID/sensor device.

FIG. 3 is a flow chart illustrating for managing a heterogeneous RFID/sensor device.

FIG. 4 is a flow chart illustrating for an order for managing a heterogeneous RFID/sensor device.

### DETAILED DESCRIPTION OF THE EMBODIMENTS

Hereinafter, various aspects of the present invention will be described with reference to the accompanying drawings. The present invention will be described through embodiments in more detail so that the skilled person in the art can understand and embody the present invention.

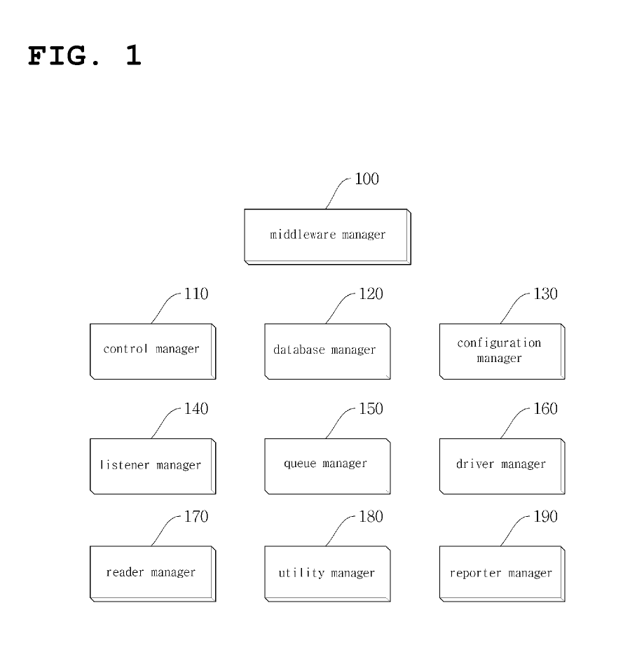

FIG. 1 illustrates a middleware for managing a heterogeneous RFID/sensor device. As shown in FIG. 1, the middleware for managing a heterogeneous RFID/sensor device includes a middleware-managing tool 100, a control manager 110, a configuration manager 130, a queue manger 150, a database manager 120, a utility manager 180, a reporter manager 190, a driver manager 160, a listener manager 140, and a reader manager 170. This FIG. 1 illustrates a middleware framework formed by classifying a main function of the middleware, defining interfaces, and modulating the same.

The control manager 110 generally manages a main function of a middleware. The control manager 110 generally manages the middleware so that each of a plurality of modules can perform the predefined function when a specific event generates.

The configuration manager 130 reads a configuration information of the middleware and executes each of the plurality of modules. The configuration manager 130 executes a proper module by determining the current environment of the middleware.

The queue manager 150 manages a queue where the input data is stored. The data is input to the middleware from an outside apparatus by a FIFO (first-in first-out) method. The queue manager 150 is concerned in storing the input data in a particular order.

The database manager 120 manages a database. The database stores the specific data and is managed by the database manager 120.

The utility manager 180 manages a utility necessary to a function of the each of the modules. The modules may use different utilities when performing the predetermined function. Accordingly, the utility manager 180 manages the utilities.

The reporter manager 190 sends a data result processed by the middleware. When the data is processed at the middleware according to the specific event, the reporter manager 190 sends the data result in order to report an end of the event.

The driver manager 160 manages a driver (such as a reader driver for a data patch of the reader, a reporter driver processing the patched data and sending the processed data, etc.) by interworking with a middleware-managing tool 100.

In the middleware for managing the heterogeneous RFID/sensor device according to the embodiment, the device driver is managed by the module of the middleware framework. Also, the device driver is defined, each device driver is implemented by each device newly added, and the each device driver is registered by the middleware-managing tool 100.

The reader manager 170 manages a reader, and the listener manager 140 manages a listener.

In order to dynamically manage the device, the middleware manger 100 notifies the fact that the device generates and the information changes to the middleware so that the changed information can be applied.

The middleware manger 100 manages the information required for managing the device information in a XML (extensible markup language) format. A module for managing a driver to implement a reader interface is designed.

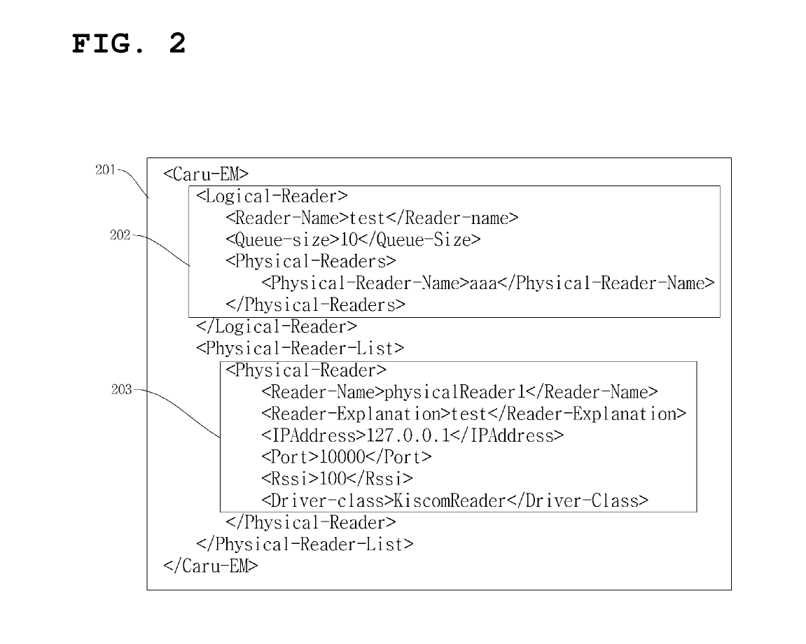

FIG. 2 illustrates a XML document for managing the heterogeneous RFID/sensor device. As shown in FIG. 2, the XML format document 201 is displayed by a logical reader 202 and a physical reader 203.

By displaying the device information through two readers, the apparatus for managing the heterogeneous RFID/sensor device can be used without depending on the device. That is, the data can be requested by the logical reader 202, which is a logical concept, without knowing the information of the actual device used for the application. Thus, the apparatus for managing the heterogeneous RFID/sensor device can be used without depending on the types of the actual physical readers 203 and the changes of the actual physical readers 203.

The physical reader 203 displays the actual device information, and defines a device name (a reader name), an internet protocol (IP) address for connecting to a network, a port number, and a driver implementing a device interface.

The logical reader 202 defines the actual device information (a physical reader name) and the queue information for storing the data which is sent from the reader.

By defining the device information as in the above, the middleware manages the connection and communication with the device based on the middleware device XML. Also, the device information dynamically changed is notified to the middleware by the middleware-managing tool 100 and the changed information is updated. The XML information may be made and updated through a registration/deletion-managing menu by using the middleware-managing tool 100.

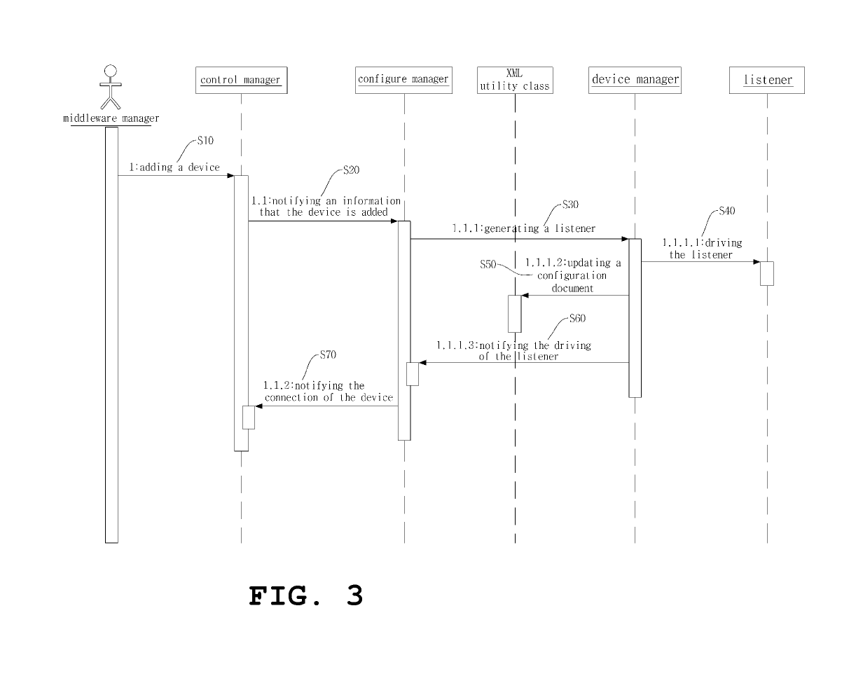

FIG. 3 is a flow chart illustrating for managing a heterogeneous RFID/sensor device. As shown in FIG. 3, an information that a device is added is notified when the device is added. That is, the information that the device is added is notified to the configure manager (S20) if the device is added (S10).

After notifying the information that the device is added, a listener generates (S30). The listener is generated by a control of the device manager if the information that the device is added is notified to the configure manager.

The generated listener is drove (S40).

If the listener generates, the configuration document of the device is updated (S50). If the listener generates, the configuration document is updated through reading the device information by a XML utility class.

After updating the configuration document of the device, the driving of the listener is notified (S60). The device manager notify the fact that the device is currently connected to the configure manager (S70).

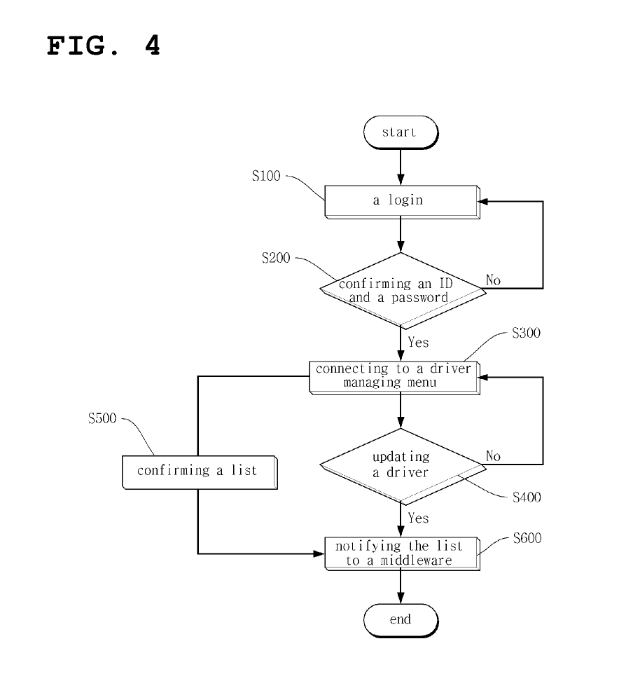

FIG. 4 is a flow chart illustrating for an order for managing a heterogeneous RFID/sensor device. As shown in FIG. 4, after a login (S100), it is determined whether an ID and a password is correct (S200). If the password is confirmed, it is connected to a driver-managing menu (S300). The driver is updated at the driver managing menu (S400) and the list is confirmed (S500). The confirmed list is notified to the middleware (S600) in order to connect the device.

According to the embodiments, the middleware can be used without any modifications when the new RFID/sensor is added, and thus, various RFID/sensors can be connected and the cost can be reduced.

Thus, various devices can be used, and thus the embodiment has the superior compatibility.

Although embodiments have been described with reference to a number of illustrative embodiments thereof, it should be understood that numerous other modifications and embodiments can be devised by those skilled in the art that will fall within the spirit and scope of the principles of this disclosure.

What is claimed is:

1. A system for managing a heterogeneous RFID/sensor device, comprising:
a control manager for generally managing a main function of a middleware;
a configuration manager for reading a configuration information of the middleware and executing each of modules;
a queue manager for managing a queue where an input data is stored;
a database manager for managing a database;
a utility manager for managing a utility necessary to a function of the each of the modules;
a reporter manger for sending a data result processed by the middleware; and
a driver manager for managing a driver by interworking with a middleware-managing tool.

2. The apparatus of claim 1, wherein the data is input and output by a FIFO (first-in first-out) method.

3. The apparatus of claim 1, wherein the middleware-managing tool notifies to the middleware when a device generates or a device information changes.

4. The apparatus of claim 1, wherein the middleware-managing tool manages the device information in a XML (extensible markup language) format.

5. The apparatus of claim 4, wherein the XML format document is displayed by a logical reader and a physical reader.

6. The apparatus of claim 5, wherein the logical reader comprises the device information and the queue information.

7. The apparatus of claim 5, wherein the physical reader comprises a device name, an internet protocol (IP) address for connecting to a network, a port number, and an information of a driver implementing a device interface.

8. A method for managing a heterogeneous RFID/sensor device, comprising:
notifying an information that a device is added when the device is added;
generating a listener after notifying the information that the device is added;
driving the generated listener;
updating a configuration document of the device if the listener is generated;
notifying the driving of the listener after updating the configuration document of the device; and
notifying the connection of the device after notifying the driving of the listener.

9. The method of claim 8, wherein the information that a device is added is notified to a configure manager.

10. The method of claim 8, wherein the listener is generated by a control of a device manager.

11. The method of claim 8, wherein the updating the configuration document is performed through reading the device information by a XML utility class.

12. The method of claim 8, wherein the driving of the listener is notified to a configure manager.

13. The method of claim 8, wherein the connection of the device is notified by a configure manager.
